(19) United States
(12) Patent Application Publication
(10) Pub. No.: US 2025/0353994 A1
(43) Pub. Date: Nov. 20, 2025

(54) TRANSPARENT PHOTOTHERMAL COMPOSITIONS, PRODUCTION METHODS AND USES THEREOF

(71) Applicant: CITY UNIVERSITY OF HONG KONG, Kowloon (HK)

(72) Inventors: Denvid LAU, Kowloon (HK); Rui TANG, Kowloon (HK)

(21) Appl. No.: 19/087,333

(22) Filed: Mar. 21, 2025

Related U.S. Application Data
(60) Provisional application No. 63/649,852, filed on May 20, 2024.

(51) Int. Cl. C08K 3/30; C03C 17/00; C03C 17/32; C03C 17/34; C08J 3/205; C08K 7/00

(52) U.S. Cl. CPC C08K 3/30; C03C 17/009; C03C 17/32; C03C 17/3494; C08J 3/2053; C08K 7/00; C03C 2217/465; C03C 2217/475; C03C 2217/48; C03C 2217/76; C03C 2218/114; C03C 2218/32; C08J 2333/00; C08K 2003/3045; C08K 2201/011; C08K 2201/016

(57) ABSTRACT

Disclosed herein is a transparent photothermal composition, which includes nonstoichiometric copper sulfide (Cu₂₋ₓS, 0<x≤1) nanoparticles dispersed in an acrylic resin, wherein the Cu₂₋ₓS (0<x≤1) nanoparticles are nanorods independently having an aspect ratio ranged from 2.2 to 3.6 and exhibit at least 95% absorption of a near-infrared (NIR) light ranged from 800 to 1,100 nm. Also disclosed herein are methods of producing the transparent photothermal composition and uses of the transparent photothermal composition in protecting a glass substrate from icing in a cold surrounding.

### CROSS-REFERENCE TO RELATED APPLICATIONS

This application claims priority and the benefit of U.S. Provisional Patent Application No. 63/649,852, filed May 20, 2024, the entirety of which is incorporated herein by reference.

### BACKGROUND OF THE INVENTION

### 1. Field of the Invention

The present invention relates to a transparent photothermal composition, its production method and uses thereof. Specifically, the present disclosure relates to the production and uses of a transparent photothermal composition, which comprises nonstoichiometric copper sulfide nanoparticles with superior photothermal property.

### 2. Description of Related Art

Ice formation on diverse surfaces becomes a formidable challenge associated with harsh environments, with glass being particularly vulnerable. Ice accumulation on glass surfaces poses considerable safety and functional hazards in various domains. For instance, icing on vehicle windshields obscures vision, increasing the risk of transportation accidents. In the aerospace sector, water condensation on aircraft windows due to the significant temperature difference between the interior and exterior leads to potential glass rupture, threatening instrument accuracy and flight safety. Additionally, ice-covered windows in residential and commercial structures comprise thermal comfort and energy efficiency. Conventional deicing strategies primarily include mechanical scraping, chemical deicing agents, and electric heating systems. However, mechanical ice removal requires manual intervention and proves ineffective for thicker ice accumulation. Chemical deicers, such as chloride solutions, reduce the freezing point of water to inhibit ice formation, but they are limited by concerns regarding the environment contamination and glass corrosion. Electric heating systems are frequently used in automotive and aerospace sectors to increase surface temperature for deicing purposes, while they result in uneven heat distribution and inconsistent glazing stresses. These inherent limitations inspire the exploration of innovative passive anti-icing and active deicing coatings and materials.

Recent research indicated that effective passive anti-icing coatings incorporate one of several features, such as prevention of water droplets adhesion to glass, retardation of ice nucleation, or reduction of ice-adhesion strength through hydrophobic and icephobic surface modification. For instance, a transparent superhydrophobic coating composed of silica films was developed via the sol-gel method to prevent water droplets from adhering to glass surfaces. The fabrication of transparent icephobic coatings through the combination of bio-based epoxy and silanes presents low ice-adhesion strength in passive anti-icing applications. However, ensuring effectiveness of ice prevention under low temperature conditions is challenging due to rapid water condensation and facilitated ice accretion. Furthermore, degradation of icephobic materials and displacement of water during freeze-thaw cycles compromise the passive anti-icing behavior of coatings. To address these issues, heating the glass surfaces by functional coatings has been demonstrated as an efficient active deicing strategy. Currently, transparent electric heating coatings and conductive glass display commendable deicing capabilities using electric energy. However, the intricate and demanding fabrication methods severely restrict the broad-scale application. The utilization of secondary energy sources also generates additional waste. Thus, the selection of appropriate coatings and materials that enhance active deicing performance using clean solar energy is essential.

In view of the above, there exists in the related art a need of an improved method and coating material that achieves efficient deicing without added energy from outside or by use of clean solar energy per se.

### SUMMARY

The first objective of the present disclosure therefore aims to provide a transparent photothermal composition, which includes a nonstoichiometric copper sulfide (Cu₂₋ₓS, 0<x≤1) nanoparticle dispersed in an acrylic resin, wherein the Cu₂₋ₓS (0<x≤1) nanoparticle is a nanorod with an aspect ratio of 2.2 and exhibits at least 95% absorption of a near-infrared (NIR) light ranged from 800 to 1,100 nm.

The second aspect of the present disclosure aims to provide a method of producing a transparent photothermal composition. The method includes steps of:
(a) dissolving copper chloride and polyethylenimine (PEI) in water to produce a first solution;
(b) reacting the first solution with sodium sulfide at about 85° C. for 15 minutes;
(c) cooling the product of step (b) to about 0° C. for 30 minutes;
(d) adding acetone to the cooled product of step (c);
(e) centrifuging the product of step (d) and collecting the precipitate thereof;
(f) drying the precipitate of step (e) to produce a dispersion of nonstoichiometric copper sulfide (Cu₂₋ₓS, 0<x≤1) nanoparticles;
(g) mixing the dispersion of Cu₂₋ₓS (0<x≤1) nanoparticles of step (f) with an acrylic resin at a ratio of 1:9 by weight to produce a mixture; and
(h) sonicating the mixture of step (g) for 5 minutes to produce the transparent photothermal composition.

According to preferred embodiments of the present disclosure, each of the Cu₂₋ₓS (0<x≤1) nanoparticles is a Cu₂₋ₓS (0<x≤1) nanorod with an aspect ratio of 2.2 and exhibits at least 95% absorption of a near-infrared (NIR) light ranged from 800 to 1,100 nm.

The third aspect of the present disclosure thus is directed to a method of a method of protecting a substrate from icing in a cold surrounding. The method includes steps of:
(1) applying a layer of the present transparent photothermal composition on the substrate; and
(2) curing the product of step (1) at room temperature for 72 hours to turn the transparent photothermal composition on the substrate to a transparent photothermal composite; wherein, the transparent photothermal composite can reach a plateau temperature of 65° C. under the NIR irradiation within 5-6 minutes without additional power supply.

According to optional embodiments of the present disclosure, step (1) is repeated for 2 to 3 times before proceeding to step (2).

According to preferred embodiments of the present disclosure, each of the Cu₂₋ₓS (0<x≤1) nanoparticles is a Cu₂₋ₓS (0<x≤1) nanorod.

According to embodiments of the present disclosure, the cold surrounding has a temperature from about 0° C. to −20° C.

According to preferred embodiments of the present disclosure, the substrate is a glass.

Other and further embodiments of the present disclosure are described in more detail below.

### BRIEF DESCRIPTION OF THE DRAWINGS

The disclosure will become more fully understood from the detailed description and the drawings given herein below for illustration only, and thus does not limit the disclosure, wherein:

FIG. 1 is a flow chart illustrating steps of a method 10 for producing a photothermal composition in accordance with one preferred embodiment of the present disclosure;

FIG. 2 is line graph depicting the absorbance of the present nonstoichiometric copper sulfide nanoparticles in the wavelength ranged from 400 nm to 1,100 nm in accordance with one embodiment of the present disclosure;

FIG. 3 depicts the absorption spectrum of the present transparent photothermal coatings and clear acrylic resin paint matrix in the wavelength ranged from 500 nm to 1,100 nm in accordance with one embodiment of the present disclosure;

FIG. 4 is a plot depicting the changes in the temperature of the present transparent photothermal coatings or clear acrylic resin paint with time in accordance with one embodiment of the present disclosure; and

FIG. 5 is a plot depicting the changes in the temperature of the present transparent photothermal coating on glass or clear acrylic resin paint on glass during deicing process in accordance with one preferred embodiment of the present disclosure.

### DETAILED DESCRIPTION

Detailed descriptions and technical contents of the present disclosure are illustrated below in conjunction with the accompanying drawings. However, it is to be understood that the descriptions and the accompanying drawings disclosed herein are merely illustrative and exemplary and not intended to limit the scope of the present disclosure.

### 1. Transparent Photothermal Composition

The first objective of the present disclosure aims at providing a transparent photothermal composition suitable for protecting outdoor glass surfaces from icing when the surrounding temperature drops to freezing temperature or below the freezing temperature. The transparent photothermal composition is characterized by having nonstoichiometric copper sulfide (Cu₂₋ₓS, 0<x≤1) nanoparticles dispersed in an acrylic resin.

The term “nonstoichiometric copper sulfide nanoparticles” or “Cu₂₋ₓS nanoparticles (0<x≤1)” as used herein refers to copper sulfide that exists in various crystal structures and stoichiometrics varying from the most copper-rich high/low chalcocite Cu₂S to the most copper-poor covellite CuS. These nanoparticles exhibit intense localized surface plasmon resonance (LSRP), which can be defined as nanoparticles much smaller than the wavelength of the incident light in size, exhibiting collective oscillation of free carriers when the frequency of electromagnetic wave matches the frequency of free carriers oscillating against the restoring force of oppositely charged carriers. Due to the absence of any free holes, the full stoichiometric Cu₂S is LSRP inactive, while the nonstoichiometric Cu₂₋ₓS nanoparticles are all in LSRP-active state.

The Cu₂₋ₓS nanoparticles exist in various shapes and structures, such as nanospheres, nanodisks, and nanorods. According to embodiments of the present disclosure, the present Cu₂₋ₓS (0<x≤1) nanoparticles are nanorods independently having an aspect ratio ranged from 2.2 to 3.6, such as 2.2, 2.3, 2.4, 2.5, 2.6, 2.7, 2.8, 2.9, 3.0, 3.1, 3.2, 3.3, 3.4, 3.5, and 3.6; more preferably, the Cu₂₋ₓS nanoparticles are nanorods with an aspect ratio of 2.2.

According to further embodiments of the present disclosure, the present Cu₂₋ₓS nanoparticles independently exhibit at least 95% absorption of a near-infrared (NIR) light ranged from 800 to 1,100 nm, such as 95%, 96%, 97%, 98%, 99% or 100% absorption of NIR light ranged from 800 to 1,100 nm, thereby rendering the present composition capable of reaching temperature above 60° C. within a few minutes (i.e., anti-icing property).

### 2. Methods for Producing Transparent Photothermal Composition

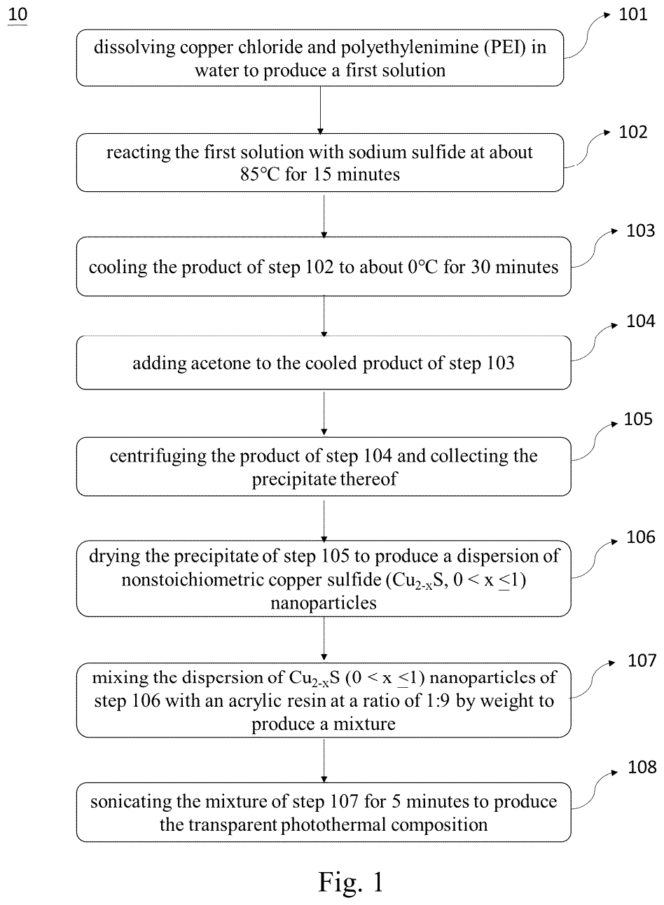

The second aspect of the present disclosure thus aims to provide a method of producing the present transparent photothermal composition. Reference is made to FIG. 1, which is a flow chart illustrating detail steps of a method 10 for producing the present transparent photothermal composition.

The method starts by dissolving copper chloride and polyethylenimine (PEI) in water to produce a first solution (step 101), which is then reacted with sodium sulfide at about 85° C. for 15 minutes to produce the Cu₂₋ₓS nanoparticles (step 102). According to preferred embodiments of the present disclosure, the Cu₂₋ₓS nanoparticles thus produced are Cu₂₋ₓS nanorods independently having an aspect ratio of 2.2 and exhibit at least 95% absorption of NIR light ranged from 800 to 1,100 nm.

Following the formation of nanoparticles in step 102, the nanoparticles are then cooled to 0° C. for 30 minutes (step 103). Subsequently, acetone is added to the cooled product of step 103 to produce a solution with acetone (step 104). The solution with acetone of step 104 is then centrifuged, and the precipitate thereof is collected (step 105). Preferably, the solution with acetone of step 104 is centrifuged at 8,000 rpm for 30 minutes to concentrate the nanoparticles and remove any unreacted reactants. After centrifugation, the precipitate of step 105 is dried, preferably in an oven of 80° C. for overnight, to produce a dispersion of nonstoichiometric copper sulfide (Cu₂₋ₓS, 0<x≤1) nanoparticles (step 106).

To produce the present transparent photothermal composition, the dispersion of Cu₂₋ₓS (0<x≤1) nanoparticles of step 106 is mixed with an acrylic resin at a ratio of 1:9 by weight to produce a mixture (step 107); which is sonicated for 5 minutes to produce the desired composition of the present disclosure (step 108).

### 3. Uses of Transparent Photothermal Composition

As described above, the present Cu₂₋ₓS (0<x≤1) nanoparticles exhibit 95% absorption of NIR light ranged from 800 to 1,100 nm, thus endowing the present transparent photothermal composition photothermal property suitable for outdoor applications, such as protecting outdoor glass surfaces from icing when the surrounding temperature drops to freezing temperature or below the freezing temperature.

The present disclosure thus also encompasses the uses of the present transparent photothermal composition, in which the present transparent photothermal composition is applied onto a substrate, preferably onto the surface of a glass, to protect the substrate from icing in cold surroundings. Specifically, the method includes steps of:
(1) applying a layer of the present transparent photothermal composition on the substrate; and
(2) curing the product of step (1) at room temperature for 72 hours to turn the transparent photothermal composition on the substrate to a transparent photothermal composite, wherein, transparent photothermal composite can reach a plateau temperature of 65° C. under the NIR light irradiation within 5-6 minutes without additional power supply.

Alternatively or in addition, step (1) of the present method may be repeated for 2 to 3 times before proceeding to step (2).

According to preferred embodiments of the present disclosure, the Cu₂₋ₓS (0<x≤1) nanoparticles comprised in the transparent photothermal composition are Cu₂₋ₓS (0<x≤1) nanorods independently having an aspect ratio of 2.2 and exhibit at least 95% absorption of a near-infrared (NIR) light ranged from 800 to 1,100 nm.

According to some embodiments of the present disclosure, the temperature of the transparent photothermal composite on the substrate can rapidly increase from 16.5° C. to over 50° C. within 20 seconds and reaches a plateau temperature of 65° C. within 5-6 minutes without additional power supply.

According to embodiments of the present disclosure, the cold surrounding has a temperature from about 0° C. to −20° C.

According to preferred embodiments of the present disclosure, the substrate is a glass of a building, an automobile or an aircraft.

The present invention will now be described more specifically with reference to the following embodiments, which are provided for the purpose of demonstration rather than limitation. While they are typically of those that might be used, other procedures, methodologies, or techniques known to those skilled in the art may alternatively be used.

### EXAMPLES

### Material and Methods

### Fabrication of Transparent Photothermal Coating

An aqueous-based approach was employed for Cu₂₋ₓS nanoparticle synthesis. The synthesis of aqueous Cu₂₋ₓS nanoparticles was initiated by dissolving 13.4 mg of CuCl₂ and 2.0 mL of the 50 mg/mL PEI solution in 100 mL deionized water. The solution underwent the magnetic stirring for 10 min, after which 1.0 mL of freshly prepared 0.1 M Na₂S was added and reacted at 85° C. for 15 min. The dark green of the solution indicated the formation of Cu₂₋ₓS nanoparticles. Following the reaction, the product was then cooled in an ice bath for 30 min to quench the reaction. Subsequently, acetone was incorporated into the mixture to achieve the solution with 75% acetone composition. The water dispersed Cu₂₋ₓS nanoparticles were separated by centrifugation at 8,000 rpm/min for 30 min, to concentrate the dispersion and remove the free reactants. Finally, the drying of Cu₂₋ₓS nanoparticles was carried out in an oven maintained at 80° C. overnight to form high concentration Cu₂₋ₓS photothermal nanoparticle solution.

To coat a glass with a transparent photothermal coating, the bare glass substrate was first cleaned by immersing in acetone for 30 min, followed by rinsing with deionized water 4 times. Two sets of glass substrate were prepared: one set was coated with photothermal coating (photothermal group) and the other set was coated with clear acrylic resin paint (control group). To ensure reliability and durability, Cu₂₋ₓS photothermal nanoparticles were combined with transparent waterborne acrylic resin paint at a 1:9 mass ratio, effectively protecting the photothermal nanoparticles from degradation. The mixture was then uniformly sonicated for 5 min. This mixture was uniformly applied using a nylon brush to mimic the practical brushing work, with the process repeated three times to achieve consistent coverage and nanoparticle distribution. The coatings were cured at room temperature for 72 h. The fabrication process prepared the transparent photothermal coating used in subsequent optical and photothermal tests.

### Optical Characterizations

The visual transmittance of transparent photothermal coating was obtained through a light transmittance meter (LH-221). Different spectral regions of sunlight hold varying energy levels, with the visible to NIR range encompassing approximately 95% of solar energy. Given the pronounced absorption capabilities of Cu₂₋ₓS nanoparticles at the wavelength band around 1,100 nm, the Vis-NIR absorption spectrum of Cu₂₋ₓS nanoparticles in the wavelength band of 400-1100 nm was characterized by a Vis-NIR spectrophotometer (Agilent Cary 5000). Optical images were captured using a Nikon Z6 camera. In photothermal-related tests, an 808-nm continuous-wave NIR laser with a power of 1 W/cm² (FU808ADX-F34) served as the simulated light source. Infrared thermal images and surface temperature variations of Cu₂₋ₓS nanoparticles and transparent photothermal coating were documented using a thermal imaging camera (FLIR T1050sc).

### Photothermal Tests

To measure the photothermal conversion and photothermal deicing performance of transparent photothermal coatings, a custom device was prepared. The device consisted of a climate chamber, an infrared thermal camera, a visual observation window, and an 808 nm-NIR laser. Photothermal conversion and deicing tests were conducted to evaluate the photothermal conversion performance and active deicing capabilities of the coatings.

The photothermal conversion test involved glass samples coated with a transparent photothermal coating and was performed at a room temperature of 25° C. First, the sample was placed 25 cm away from an 808-nm NIR laser. Then, the sample was continuously exposed to the laser at a power of 1 W/cm². Surface temperature variations were recorded using the infrared thermal camera.

The photothermal deicing performance was assessed under a static low temperature of −20° C. The specific operation of the deicing process was as follows: First, the samples consisting of glass substrate and photothermal coatings were coated with deionized water and stored in a refrigerator at −30° C. for 24 h to create a uniform 3 mm thick ice layer on the coating surface. After ice formation, the ice-covered samples were placed in the climate chamber to maintain a consistent ambient temperature of −20° C. The samples were then subjected to an 808 nm-NIR irradiation during the deicing process, and the infrared thermal camera recorded the surface temperature changes as the ice melted. Photothermal deicing continued until the surface temperature suddenly exceeded 0° C., resulting in the melting of the ice beads observed on the surface.

### Example 1: Optical and Thermal Properties of the Present Transparent Thermal Coatings

### 1.1 The Cu₂₋ₓS Nanoparticles

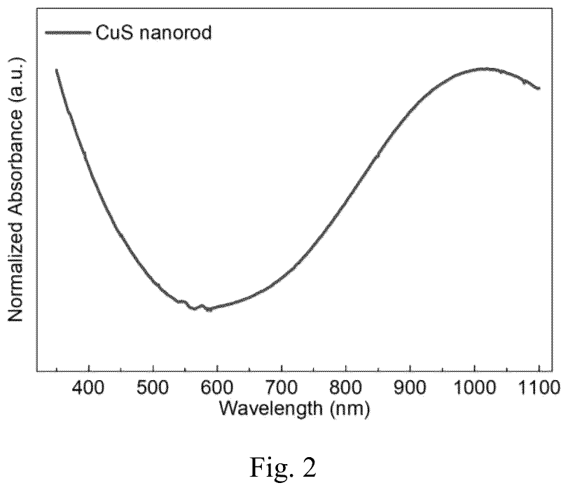

The Cu₂₋ₓS nanoparticles were prepared in accordance with procedures described in the “Materials and methods” section, the procedures were tailored to produce nanoparticles with superior NIR light absorption capacity. As depicted in FIG. 2, the nanoparticles possessed outstanding NIR absorptivity in the wavelength range from 800 nm to 1,100 nm and diminished absorption within the visible range, thus promoting the temperature rise under the NIR laser. Further, by controlling the concentration of PEI during synthesis, the synthesized nanoparticles exhibited an aspect ratio of 2.2 (data not shown).

### 1.2 the Transparent Thermal Coating

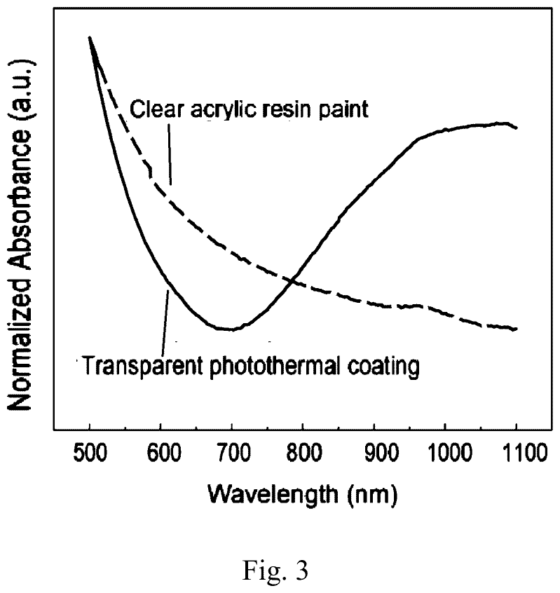

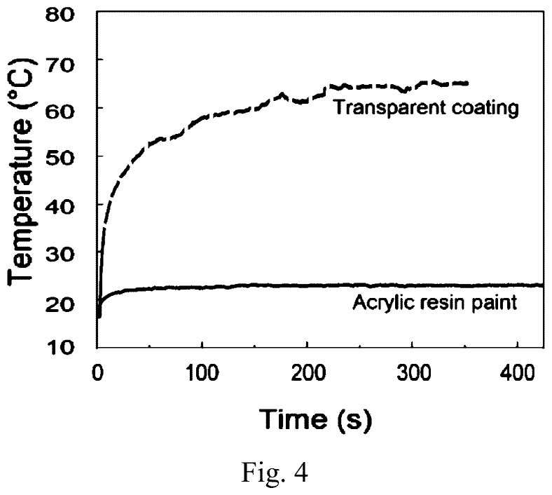

The present Cu₂₋ₓS nanoparticles of Example 1.1 were used as additives and mixed with transparent waterborne acrylic resin paint to produce the present transparent thermal composition, which was then brush-coated onto the surface of a glass substrate to form a uniform and highly transparent photothermal coating upon curing. The photothermal coating on the glass substrate was then subjected to photothermal conversion and photothermal deicing tests. Results are illustrated in FIGS. 3 and 4.

The coating demonstrated a light transmittance of 62.4% in the visible region, while exceeding 95% light absorbance in the NIR region. It showcased the acceptable visual transmittance while efficiently absorbing NIR irradiation for photothermal heating. The absorptivity of Cu₂₋ₓS nanoparticles, clear waterborne acrylic resin paint and the prepared transparent photothermal coating were measured respectively to demonstrate the effects of Cu₂₋ₓS nanoparticles on the light absorbance of coatings. As depicted in FIG. 3, the absorptivity of the present Cu₂₋ₓS nanoparticles was concentrated in the NIR wavelength range (800-1100 nm), with an absorption peak around 1,050 nm. In contrast, the clear acrylic resin paint exhibited minimal absorption in the NIR irradiation. Thus, the high NIR irradiation absorption of the transparent photothermal coating was attributed to the addition of Cu₂₋ₓS nanoparticles of Example 1.1 rather than the clear acrylic resin paint matrix. Meanwhile, when the transparent photothermal coating containing Cu₂₋ₓS nanoparticles of Example 1.1 was exposed to 808 nm NIR light (1 W/cm²), the coating presented a rapid temperature increase (localized temperature rising from 16.5° C. to over 50.0° C. within 20 s) and reached a plateau temperature of 65.0° C. within 5-6 min (FIG. 4). This indicated the superior photothermal light-to-heat conversion performance of coatings. The Cu₂₋ₓS nanoparticles of Example 1.1 exhibit a heat generation rate that surpasses any potential losses through conduction, convection, or radiation. In contrast, the control group lacking photothermal nanoparticles shows no change in temperature when exposed to NIR radiation. This is attributed to the low absorption of NIR light by the samples, with most of the light being transmitted or reflected instead of being converted into heat energy. Compared to the transparent photothermal coating, the temperature of the clear acrylic resin paint coated on glass remained virtually unchanged even after 400 s of NIR irradiation (only increasing from 17.5° C. to 22.0° C.), with clear confirmation that the photothermal performance of transparent coatings was derived from the Cu₂₋ₓS nanoparticles. Thus, the high NIR irradiation absorption and high photothermal conversion efficiency of the transparent photothermal coating, achieved by the incorporation of Cu₂₋ₓS nanoparticles and clear acrylic resin paint, make it a promising coating material for deicing applications on glass substrates.

### 1.3 Dicing Performance of the Transparent Thermal Coating of Example 1.2

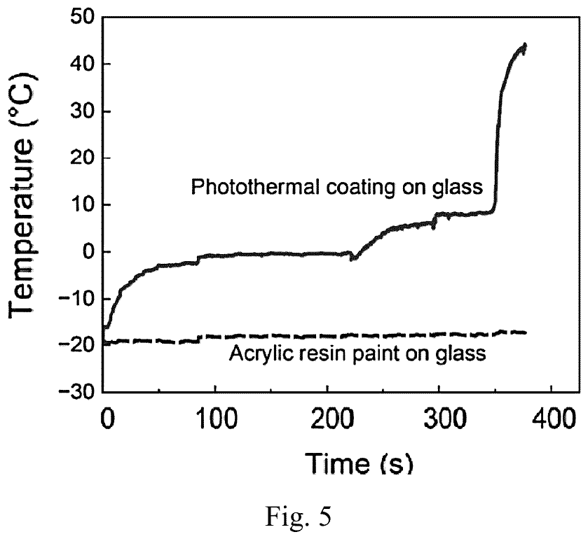

To investigate the respective influence of Cu₂₋ₓS nanoparticles and acrylic polymers on the deicing performance of the transparent photothermal coating of Example 1.2, a comparison was conducted among uncoated glass, glass coated with pure clear acrylic resin paint, and glass coated with transparent photothermal coating. To simulate the photothermal deicing behavior of the actual ice layer on the coating/glass, a photothermal deicing test under −20° C. surroundings was carried out. Due to the limited 10 mm*10 mm rectangular irradiation area of the NIR laser, the ice melting time was measured as the period for an ice bead corresponding to the irradiation area among the ice layer to fully melt into water. Considering the critical phase transition temperature of 0° C. for ice-to-water conversion, the inflection point observed on the temperature-time curves during the deicing process was identified as the ice melting time (FIG. 5). The swift temperature rise indicated the heat consumption generated by the photothermal coating from deicing to heating the coating, suggesting the melting of ice beads. Initially, the coating absorbs NIR light and generated heat to facilitate ice removal, thereby maintaining a temperature around 0° C. due to the energy consumption during the phase change from ice to water. Once the completion of ice melting, the heat generated by the coating was primarily used for heating the coating itself, resulting in rapid temperature increase to over 40° C. This observation was consistent with findings in FIG. 4, where a similar rapid temperature increase was observed within 50 seconds. Under 6 min of continuous irradiation, the ice surface temperature on the transparent photothermal coating rapidly increased from −20° C. to 42.5° C., with the ice melting time around 220 s. In contrast, the temperature of the uncoated glass and glass with pure acrylic resin coating remained relatively unchanged, indicating that the heat provided by the NIR laser alone was insufficient to melt the ice. Thus, the photothermal performance of the coating was primarily attributed to the presence of Cu₂₋ₓS nanoparticles. Further, at −20° C. surroundings, the ice bead on transparent photothermal coating completely melted into water within 4 min, while ice beads on the uncoated glass and clear acrylic resin paint remained frozen (data not shown). This observation was attributed to the photothermal impact of Cu₂₋ₓS nanoparticle on the conversion of light energy to thermal energy, thereby melting ice beads.

In sum, data of the present disclosure confirmed that the Cu₂₋ₓS nanoparticles of the present disclosure possess superior NIR absorption, thus conferring the photothermal coating produced therefrom with superior photothermal conversion efficiency, in which the temperature of the coating could reach 65° C. under NIR irradiation within 6 minutes. The present photothermal coating thus may serve as a candidate for practical applications on outdoor glass surfaces of buildings, automobiles, and aircraft in cold surroundings.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of the present disclosure.

What is claimed is:

1. A transparent photothermal composition comprising a nonstoichiometric copper sulfide (Cu₂₋ₓ S, 0<x≤1) nanoparticle dispersed in an acrylic resin;
wherein,
the Cu₂₋ₓS (0<x≤1) nanoparticle is a nanorod with an aspect ratio of 2.2 and exhibits at least 95% absorption of a near-infrared (NIR) light ranged from 800 to 1,100 nm.

2. A method of producing a transparent photothermal composition comprising:
(a) dissolving copper chloride and polyethylenimine in water to produce a first solution;
(b) reacting the first solution with sodium sulfide at about 85° C. for 15 minutes;
(c) cooling the product of step (b) to about 0° C. for 30 minutes;
(d) adding acetone to the cooled product of step (c);
(e) centrifuging the product of step (d) and collecting the precipitate thereof;
(f) drying the precipitate of step (e) to produce a dispersion of nonstoichiometric copper sulfide (Cu₂₋ₓS, 0<x≤1) nanoparticles;
(g) mixing the dispersion of Cu₂₋ₓS (0<x≤1) nanoparticles of step (f) with an acrylic resin at a ratio of 1:9 by weight to produce a mixture; and
(h) sonicating the mixture of step (g) for 5 minutes to produce the transparent photothermal composition.

3. The method of claim 2, wherein each of the Cu₂₋ₓS (0<x≤1) nanoparticles is a Cu₂₋ₓS (0<x≤1) nanorod with an aspect ratio of 2.2 and exhibits at least 95% absorption of a near-infrared (NIR) light ranged from 800 to 1,100 nm.

4. A method of protecting a substrate from icing in a cold surrounding comprising:
(1) applying a layer of the transparent photothermal composition of claim 1 on the substrate; and
(2) curing the product of step (1) at room temperature for 72 hours to turn the transparent photothermal composition on the substrate to a transparent photothermal composite, wherein, the transparent photothermal composite can reach a plateau temperature of 65° C. under the NIR light irradiation within 5-6 minutes without additional power supply.

5. The method of claim 4, further comprising repeating step (1) for 2 to 3 times before proceeding to step (2).

6. The method of claim 4, wherein in step (1), a transparent photothermal composition is produced by the method of claim 4.

7. The method of claim 6, wherein the Cu₂₋ₓS (0<x≤1) nanoparticles are Cu₂₋ₓS (0<x≤1) nanorods.

8. The method of claim 4, wherein the cold surrounding has a temperature from about 0° C. to −20° C.

9. The method of claim 4, wherein the substrate is a glass.
